(19) United States
(12) Patent Application Publication
(10) Pub. No.: US 2008/0208926 A1
(43) Pub. Date: Aug. 28, 2008

(54) Data management in a data storage system using data sets

(76) Inventors: Peter L. Smoot, San Jose, CA (US); Jim Holl, Sunnycale, CA (US); Sahn Lam, Sunnyvale, CA (US); Colin Johnson, Sunnyvale, CA (US); David E. La France, Santa Clara, CA (US); Brian Hackworth, Sunnyvale, CA (US); Kostadis Roussos, Sunnyvale, CA (US); Jim Voll, Palo Alto, CA (US)

Correspondence Address: Perkins Coie LLP, P.O. Box 1208, Seattle, WA, 98111-1208, US

(21) Appl. No.: 11/710,202

(22) Filed: Feb. 22, 2007

(51) Int. Cl. G06F 7/10

(52) U.S. Cl. 707/203; 707/E17.007

(57) ABSTRACT

A method and an apparatus to manage data using data sets are presented. In one embodiment, the method includes allowing an administrator of a data storage system to define a data set having a plurality of storage objects and to associate the data set with a data management policy, wherein each of the plurality of storage objects includes a logical representation of a collection of data and replicas of the collection of data, the collection of data stored in storage containers managed by storage servers in the data storage system, wherein the storage containers are independent of the logical representation. The method may further include using a storage manager to manage the data set as a single unit according to the data management policy.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present invention relates to networked data storage systems, and more particularly, to managing data storage using data sets.

### BACKGROUND

A networked data storage system can be used for a variety of purposes, such as providing multiple users access to shared data, or facilitating backups or data mirroring. A networked data storage system may include a number of storage servers. A storage server may provide services related to the accessing and organizing data on mass storage devices, such as disks. Some of these storage servers are commonly referred to as filers or file servers as these storage servers provide file-level access to data. Some of these filers further provide clients with sub-file level access to data (e.g., block-level access). An example of such a storage server is any of the Filer products made by Network Appliance, Inc. in Sunnyvale, Calif. The storage server may be implemented with a special-purpose computer or a general-purpose computer programmed in a particular way. Depending on the application, various networked storage systems may include different numbers of storage servers.

Logical units of storage may be created and manipulated on storage servers, such as files, directories, volumes, qtrees (which is a subset of a volume, optionally associated with a space usage quota), logical unit numbers (LUNs), etc. Such logical units are referred to as storage objects in the current document. Creating a single storage object is typically fast and easy, but the difficult part comes in managing a storage object over time. A storage administrator has to make numerous decisions, such as how to monitor the available space for the storage object, how to schedule data backups, how to configure backups, whether the data should be mirrored, where data should be mirrored, etc. Answers to the above questions may be summarized in a data management policy, and once this policy is decided, the administrator needs to ensure that the policy is correctly implemented on all relevant storage objects, that the required space is available, that the data protection operations succeed, and so forth. If the administrator decides to change the policy (for example, extending the amount of time that backups should be retained), the administrator has to find all the affected storage objects and then manually re-configure all the relevant settings.

As the number of storage objects grows in the system, the administrator's job becomes more difficult and complex. It becomes increasingly likely that the administrator may not readily determine what policy was supposed to apply to a given storage object, or why a given volume is mirrored. In addition, the administrator has to perform many tedious manual tasks for each storage object, which can be error prone and unreliable. A large data center may have hundreds to over a thousand filers. Each filer may manage hundreds of volumes and thousands of qtrees. This leads to a total of tens to hundreds of thousands of volumes and qtrees to manage with a similar number of backup and mirror relationships. The number of objects is growing faster than information technology headcounts, so each administrator is managing more and more objects. Eventually, the sheer number of objects makes it infeasible, if not impossible, for an administrator to reliably implement data management policies. Thus, a storage administrator needs help tracking what storage objects exist in a storage system, how the storage objects relate to other objects, and which policies should be applied to the storage objects.

### SUMMARY

The present invention includes a method and an apparatus to manage data using data sets. In one embodiment, the method includes allowing an administrator of a data storage system to define a data set having a plurality of storage objects and to associate the data set with a data management policy. Each of the storage objects includes a logical representation of a collection of data and replicas of the collection of data. The collection of data is stored in storage containers. The storage containers are managed by storage servers in the data storage system, wherein the storage containers are independent of the logical representation of the collection of data. The method may further include using a storage manager to manage the data set as a single unit according to the data management policy.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 illustrates an embodiment of a networked storage system;

FIG. 2 illustrates an embodiment of a storage manager;

FIGS. 3A-3C illustrate an embodiment of a series of GUI screens to create a new data set;

FIG. 3D illustrates an embodiment of a GUI screen for applying a data management policy to a data set; and

FIG. 4 illustrates a flow diagram of an embodiment of a process to manage data using data sets.

### DETAILED DESCRIPTION

A method and an apparatus to manage data using data sets in a data storage system are described. In the following description, numerous specific details are set forth. However, it is understood that embodiments of the invention may be practiced without these specific details. In other instances, well-known components, structures, and techniques have not been shown in detail in order not to obscure the understanding of this description.

In one embodiment, the method includes allowing an administrator of a network data storage system to define a data set having a set of storage objects associated with a data management policy. Each storage object may include a logical representation of a collection of data and replicas of the collection of data. The collection of data is stored in one or more storage containers. The storage containers are managed by one or more storage servers in the data storage system. The storage containers are independent of the logical representation. The method may further include managing the data set as a single unit according to the data management policy using a storage manager. A single unit in the context of the following discussion is a group having one or more members, which may be manipulated by the administrator as a whole without referring to each individual member of the group. To manage the data set as a single unit, the data management policy and any changes thereof are applied to all of the storage objects in the data set. Using data sets and data management policies can vastly reduce the workload of storage administrators, as well as the risk of making errors in deploying changes in the data management policy. More details about the data sets, storage objects, and data management policy are discussed below.

### System Overview

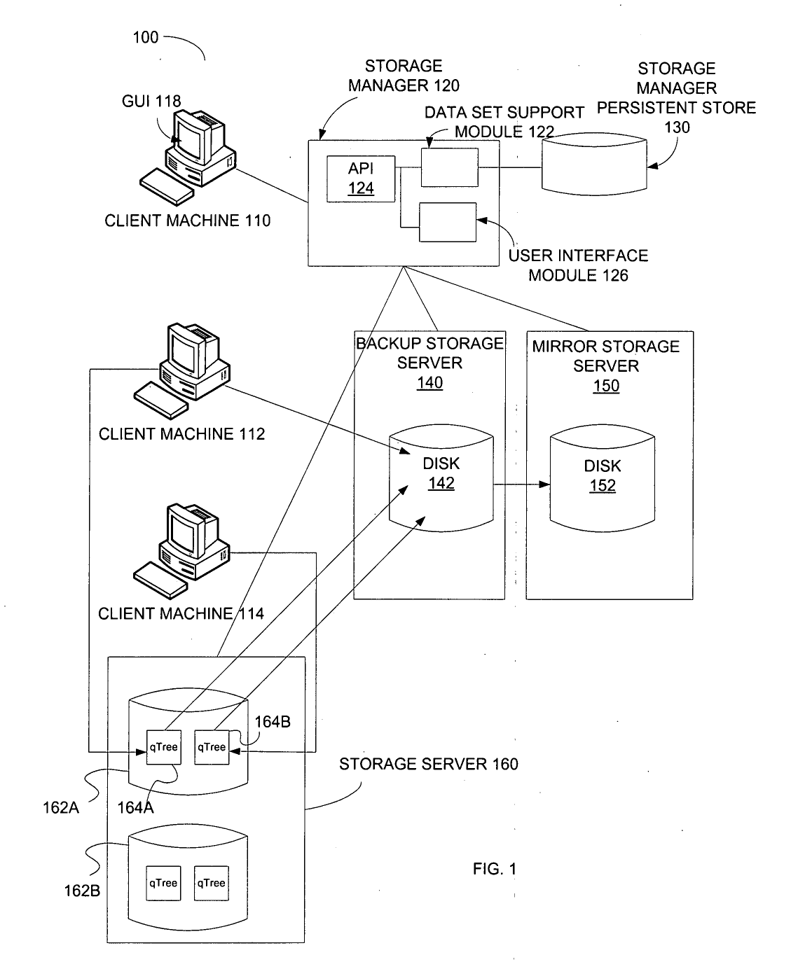

FIG. 1 shows a networked data storage system 100 according to some embodiments of the present invention. The system 100 includes client machines 110, 112, and 114, a storage manager 120, a storage manager persistent store 130, a storage server 160, a backup storage server 140, and a mirror storage server 150. The above components can be coupled to each other through one or more of various types of networks, such as local area network (LAN), wide area network (WAN), etc. Moreover, the networked connection may be wireline, wireless, or a combination of both. As such, the above components may or may not be located at different geographical locations.

In one embodiment, data is stored and transferred in units of files in the data storage system 100. Therefore, the system 100 may be a file-based networked storage system. In such an embodiment, the system 100 can be a network-attached storage (NAS) system that provides clients with access to data at the file level. A NAS system uses file access protocols to retrieve data, such as, for example, Network File System (NFS), or Common Internet File System (CIFS). The files are logically arranged into directories. A volume of storage devices may be mapped to one or more directories. Alternatively, the system 100 may include or be part of a storage area network (SAN), to provide clients with access to data at the block level of storage servers. A block is the basic unit used to store data in the SAN.

Note that any or all of the components of system 100 and associated hardware may be used in various embodiments of the present invention. However, it can be appreciated that other configurations of the networked data storage system 100 may include more or fewer devices than those discussed above.

In one embodiment, the client machine 110 is used by a storage administrator, and thus, may be referred to as an administrative client. In contrast, the other client machines 112 and 114 are used by users of the network data storage system 100 to access data, and thus, may be referred to as storage clients. Of course, a storage client and an administrative client may not be mutually exclusive, that is, both the administrator and users may use the same client machine in some embodiments. The client machines 110, 112, and 114 may be implemented on personal computers (PCs), laptop computers, special purpose computing devices, etc.

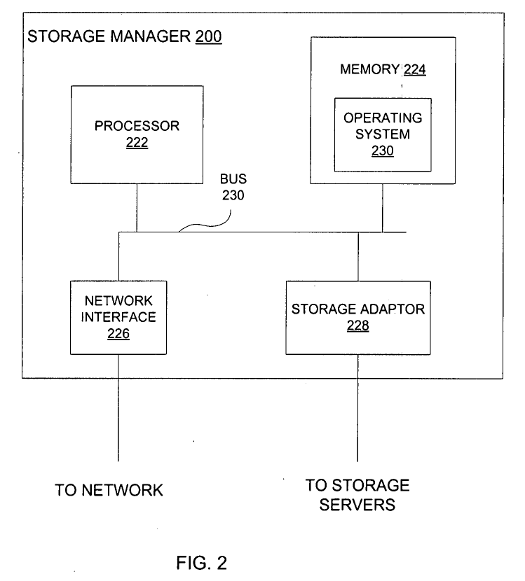

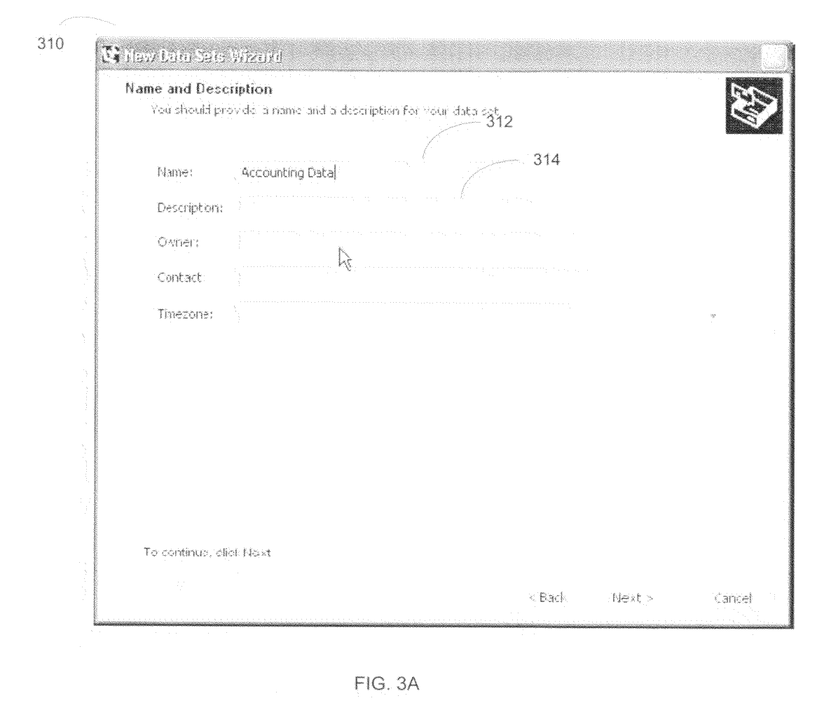

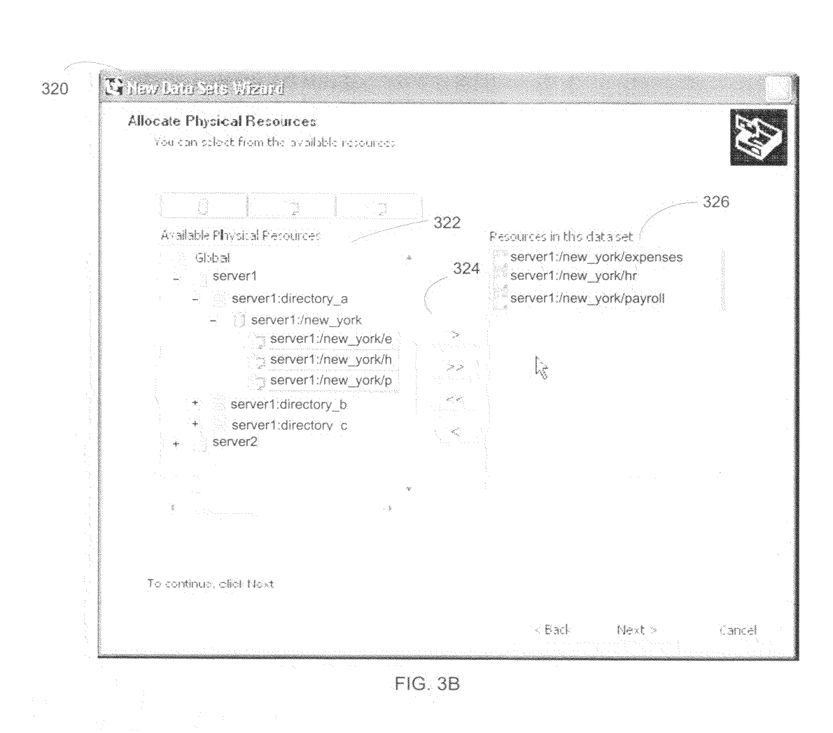

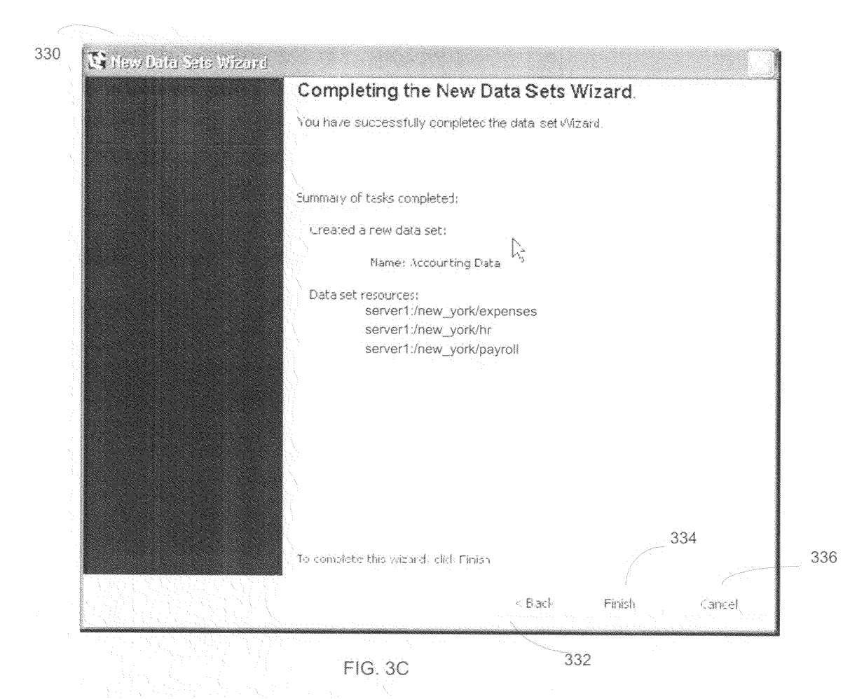

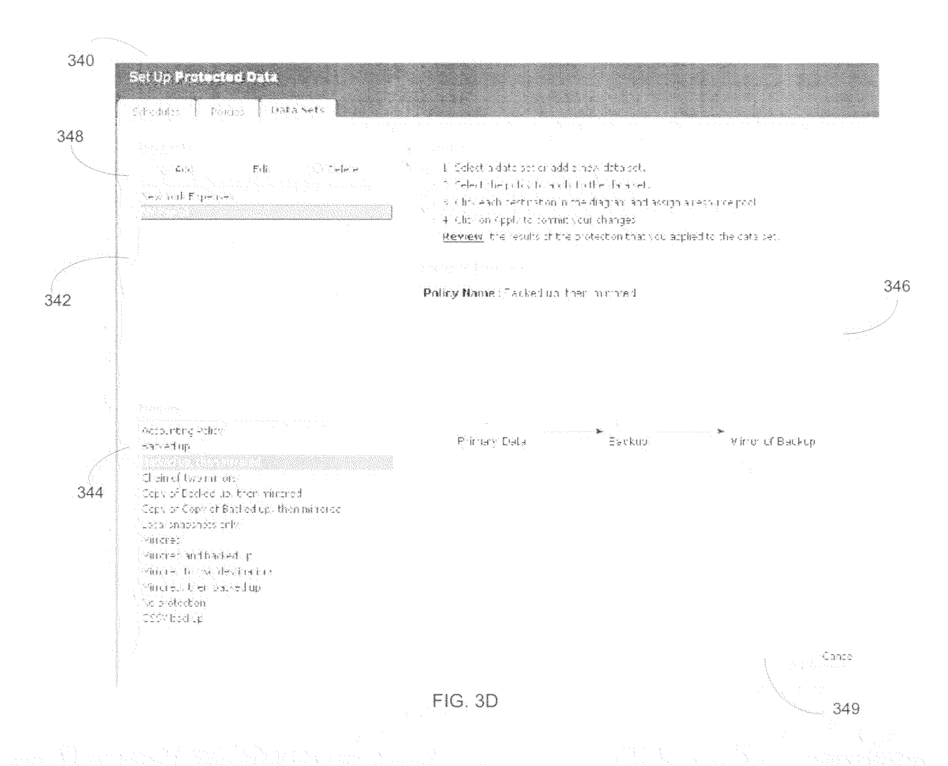

Referring back to FIG. 1, the client machine 110 is coupled to the storage manager 120, which is further coupled to the storage manager persistent store 130. The storage manager 120 may be implemented on one or more servers, personal computers (PCs), special-purpose computing machines, etc. Details of one embodiment of a machine usable to implement the data manager 120 are shown in FIG. 2. The storage manager 120 may include an application programming interface (API) 124 to interface with the client machine 110. Further, the storage manager 120 may include a data set support module 122 to manage storage using data sets. The storage manager 120 may further include a user interface module 126 to create a user interface (e.g., graphical user interface (GUI), command line interface (CLI), etc.) and to provide the user interface to the client machine 110 via the API 124. In some embodiments, the API 124 may be implemented on a separate server coupled between the storage manager 120 and the client machine 110. The client machine 110 includes a display (e.g., a monitor) to present the user interface (e.g., the GUI 118) to an administrator of the data storage system 100. Using the GUI 118, the administrator may input information of data sets and data management policies to the storage manager 120. In some embodiments, the GUI 118 is presented via a network access application, such as an internet browser, to the administrator. Some exemplary embodiments of screen displays of the GUI 118 are illustrated in FIGS. 3A-3D.

Based on the administrator inputs, the data set support module 122 may create, remove, and/or update data sets, where each data set is associated with a data management policy. Objects representing the data sets and the data management policy are stored in the storage manager persistent store 130. The storage manager persistent store 130 may be implemented using a storage device that stores data persistently, such as a disk, a read-only memory (ROM), etc. Using the data sets and the data management policies, the storage manager 120 manages data in the data storage system 100. More details of the data sets, data management policies, and data management using data sets are discussed below.

In addition to the client machine 110 and the storage manager persistent store 130, the storage manager 120 is further coupled to the storage server 160, the backup storage server 140, and the mirror storage server 150. It should be apparent that the storage servers 140, 150, and 160 are shown in FIG. 1 as examples for illustrative purpose only. Other embodiments of the data storage system may include more or fewer storage servers, each storage server managing a set of physical storage devices, such as magnetic disks, optical disks, tape drives, etc., in different configurations. Referring back to FIG. 1, the storage server 160 manages two disks 162A and 162B. The disks 162A and 162B may hold various storage containers, either in whole or in part. A storage container is a unit for storing data, such as a file, a directory, a qtree, a volume, a LUN, etc. For instance, the disk 162A holds two qtrees 164A and 164B. As another example, a disk may hold part of a volume, where the volume spans multiple disks.

The client machines 112 and 114 may access the disks managed by the storage server 160. For example, the client machine 112 stores data in the qtree 164A, while the client machine 114 stores data in the qtree 164B. To protect the data in the qtrees 164A and 164B, the storage server 160 may send the data in the qtrees 164A and 164B to the backup storage server 140, which creates a backup copy of the data in the qtrees 164A and 164B in the disk 142. In addition, the backup storage server 140 may further mirror the disk 142 onto the disk 152 managed by the mirror storage server 150. In some embodiments, the client machine 112 may store data in an internal disk (not shown) and have the internal disk backed up in the disk 142 managed by the backup storage server 140. Note that the above are merely one example of data protection policy topologies. It should be appreciated that many different data protection policy topologies may be implemented in the system 100.

One should appreciate that as the numbers of storage servers and disks grow in the networked data storage system 100, the workload as well as the complexity of data management increases. Thus, it becomes more difficult for the administrator to manually manage data in the system 100. In order to improve efficiency and to reduce the risk of making errors, the storage manager 120 automatically uses data sets to manage data in the networked data storage system 100 according to data management policies from the administrator. Details of data sets and the use of such are discussed below.

### Data Sets and Storage Objects

To efficiently manage data, the data set support module 122 in the storage manager 120 uses data sets to manage data in some embodiments. In one embodiment, a data set includes references to a set of storage objects associated with a data management policy. The data management policy is applied to the data set, directing how the administrator wishes the data in the storage objects to be managed as a single unit. In other words, a data set is a collection of storage objects grouped by virtue of the storage objects to be managed as a single unit so that the same data management policy and any changes thereof is applied to each storage object of the data set. For example, a storage object may be defined to be a home directory of an employee in a company, which is a member of a data set of the home directories of all employees in the company. The storage objects may be referred to as members of the data set. Before going further into the details of the data set and the data management policy, details of a storage object are described below.

A storage object may include a logical representation of a collection of data in one or more storage containers and replicas of the collection of data (e.g., a mirrored copy of the data and/or a backed up copy of the data). Referring back to the above example, a logical representation of the storage object of the employee's home directory may be the employee's identification (ID), such as “jsmith.” The collection of data may be created by users or the administrator of the data storage system 100. In some embodiments, the data of a storage object is stored in a storage container or a set of storage containers (e.g., the disk 162) managed by one or more storage servers (such as the storage server 160) in the data storage system 100. For instance, the content of the employee's home directory in the above example may be stored in the qtree 164A in the disk 162A.

Some examples of storage objects include data in qtrees, volumes, directories, etc. These examples may also be referred to as elementary storage objects because they are logical representation of data in basic units of storage in the networked data storage system 100. Further, a storage object may be a reference to a collection of elementary storage objects, such as a reference to all volumes managed by a storage server.

Note that the physical implementation of the storage containers is independent of the logical representation of the data. Thus, the data is not managed by where the data is stored or how the data is accessed. Rather, the data is managed by the logical representation, which may be associated with the content of the data. For instance, the data may be a word processing document, “employee_review.doc” stored in the disk 162A. In the current example, the logical representation may be the name of the document (i.e., “employee_review.doc”). The storage manager 120 may manage the document by the name of the document (i.e., “employee_review.doc”), rather than by the storage container (i.e., the disk 162A in the current example) or the set of storage containers in which the document is stored. The physical implementation of the disk 162A is independent of the name of the document (i.e., “employee_review.doc”) stored in the disk 162A. As such, the storage object, as well as the data set having the storage object, are not bound to any actual physical location or storage container and may move to another location or another storage container over time. For example, the storage containers associated with a data set may become obsolete in performance over time, and the storage manager 120 may therefore move the data to a set of new storage containers, with or without alerting the administrator. Any movement of data sets may be substantially transparent from the administrator's perspective in order to provide a separation of the logical representation from the physical location. Thus, the storage manager 120 may re-balance resources (e.g., the disks 162A, 162B, 142, and 152) in the data storage system 100 over time. In other words, the data set provides the virtualization of the physical storage containers used to hold the data.

In some embodiments, a data set includes user created data as well as meta data. Meta data may include information about the user created data. Examples of meta data include exported names, language settings, storage server association, LUN mappings, replication configuration, quotas, policies, consistency groups, etc. Meta data may be used to move or restore the corresponding data set. A complete data set backup is thus useful in handling disaster recovery scenarios. If the storage server (e.g., a filer) which hosts the primary storage set associated with the data set is destroyed, the data set may be reconstructed on another storage server using another storage set that is a replica of the primary storage set to provide client data access without manual configuration by the administrator.

Furthermore, a data set may have two types of membership of the storage objects which it contains, namely static and dynamic membership. Static members are low level storage objects (volumes, directories, LUNs), which could be managed by themselves. In other words, the elementary storage objects mentioned above are static members. Dynamic members are references to storage objects which may contain other storage objects. For example, an administrator could add a user's home directory to a data set as a static member. Alternatively, the administrator could realize that a given storage server is only used to hold home directories and add the storage server itself to a data set as a dynamic member. This saves the administrator work later because, as directories are created and destroyed on that storage server, the directories may be dynamically added to or removed from the data set.

Beyond membership, a data set aggregates the status of its members according to some embodiments of the invention. There may be multiple status parameters an administrator may wish to track. Some exemplary status parameters include a data availability status, a data protection status, and a data protection policy conformance. The data availability status indicates whether all components of the data set are available for use. The data protection status indicates that all the data set members are being protected by a data protection policy. The data protection policy conformance status indicates that the data protection mechanisms (e.g., snapshots, backups, and mirrors) have been configured in accordance with the data protection policy. The storage manager 120 may roll up the corresponding statuses of members of the data set to derive or to generate a value of the corresponding status of the data set.

In one embodiment, a status parameter may have a number of levels, each associated with a value. To combine the corresponding status parameters of the members in the data set, the storage manager 120 may select the maximum value among all the corresponding statuses of the members. For example, a status can have six possible levels: normal, information, warning, error, critical, and emergency, where normal has a value of 1, information has a value of 2, warning has a value of 3, and so forth. Suppose an exemplary data set has three members and, the corresponding status parameter values of which are 2, 3, and 5. Then the storage manager 120 may determine the corresponding status parameter value of the entire data set to be 5, which is the maximum value among the three values.

Combining individual object status parameter values into a single data set status parameter value allows the administrator to track a much smaller number of values. If the value of the status parameter of a data set is above or equal to a predetermined threshold, the administrator does not have to check the individual object status values. Conversely, if the data set status parameter is below the threshold, the storage manager 120 may alert the administrator to investigate the cause of the error. Breaking the status into multiple levels indicates to the administrator the nature of the error, giving the administrator a head start on resolving the issue.

### Operations on Data Sets

In some embodiments, the storage manager 120 may perform various operations on a data set. Some examples of operations include changing or modifying an associated data management policy of a data set, provisioning new members in a data set, listing members in a data set, adding members to a data set, deleting or removing members from a data set, migrating a data set to a different set of storage containers, generating performance views specific to a data set, generating storage usage reports of a data set, setting quota on a data set or individual members within a data set. One should appreciate that the above are merely illustrative examples of some of the operations the storage manager 120 may perform on data sets. The above list is not an exhaustive list of all of the possible operations.

### Data Management Policy

As mentioned above, the storage objects in the data set are associated with a data management policy. In general, a data management policy includes a description of the desired behavior of the associated data set. For instance, a data management policy may describe how the storage should be used and configured. One exemplary data management policy is a data protection policy, which describes how storage objects in a data set should be protected. Attributes associated with a data management policy are abstracted at the highest level possible, allowing implementation of underlying technology to change over time without adversely impacting the administrator. In other words, a layer of abstraction is provided between the administrator and the physical implementation of the storage containers in which the data is stored. The physical implementation may be modified without violating or impacting the data management policy. Thus, the administrator may be shielded from the idiosyncrasies of various underlying implementations that allow the data set to use newer technology as it becomes available in an automated fashion. Once the administrator has added the desired members to the data set, the storage manager 120 may automatically start applying the data management policy associated with the data set to all members in the data set. For instance, the storage manager 120 may configure storage objects in the data set, schedule backup of the storage objects in the data set, etc., according to the data management policy. If the administrator attempts to apply a different data management policy to a subset of storage object(s) in the data set, then the storage manager 120 may generate an error message to alert the administrator, who may respond by reassigning the subset of storage object(s) to another data set or by creating a new data set for the subset of storage object(s).

In some embodiments, one goal of data management policies is to describe attributes of the data in terms the administrator is comfortable with, and leave the configuration and choice of technologies to achieve those goals to the storage manager 120. The attributes in the policies may generally focus on desired data protection behaviors and configuration settings rather than on software technology and hardware choices. Although the choice of hardware may have some impact on the performance and cost of the storage, the physical equipment choices may be driven by a simple label scheme described in more detail below. Examples of attributes include cost, performance, availability, reliability, type of data protection, capacity related actions, security settings, capabilities, etc.

In some embodiments, the storage containers in the system 100 (may be collectively referred to as a resource pool) are labeled with user-defined strings, such as “tier-1,” “tier-2,” and “tier-3.” Such labels may be specified as a part of a provisioning policy to limit physical storage resources to a select data set. When provisioning storage, a data access name may be specified in addition to a policy for the desired behavior of the resulting data set. The data access name is used to configure the necessary export configurations (e.g., NFS, CIFS, ISCSI, FCP, etc.).

Note that the data management policy associated with a data set may be explicitly changed by the administrator. For example, as the data in tier-1 storage ages, the relevance or importance of the data may diminish, and thus, the data may be migrated to tier-2 storage from the tier-1 storage. In some embodiments, the administrator may determine which data sets are candidates for migration and associate such data sets with a policy created for data in tier-2 storage.

Various operations on data management policies are available. Some examples include policy administration and cloning. For policy administration, policies may be modified according to disaster recovery requirements or storage attributes, subject to permission allowed via the role based access control mechanism. For cloning, a new copy of a policy with identical attributes may be generated using the cloning operation.

Advantages of Data Management Using Data Sets

Using data sets and data management policies as described herein can vastly reduce the workload of storage administrators. There are at least two ways in which using data sets as described herein help reduce manual administrative work and ensure a more reliable policy implementation.

First, using data sets can reduce work by reducing the number of objects a storage administrator has to monitor. While a data center may have hundreds of thousands of directories, these may be classified into a much smaller number of collections and be managed by a smaller number of policies. For example, every user in a large enterprise may have a home directory, but these all need to be managed the same way. Thus, these home directories can be collected into a single data set associated with a data protection policy. This means that no matter how large the enterprise grows, there is no additional day-to-day management burden for the new users. When a new home directory is created, it is added, manually or automatically, to a data set containing other home directories, and the administrator may manage the data set as a single unit from then on, instead of managing thousands of home directories individually.

The second way a data set reduces work is by automating implementation of and changes to data management policies. For instance, suppose a data center originally decided user home directories should be backed up, but the secondary storage holding the backups did not need further protection. Further, suppose the administrator subsequently decided this was not adequate and that home directory backups should be mirrored to off-site storage. In a conventional environment, this would be a huge task, including, for example, tracking down all the secondary volumes which have ever held home directory backups, provisioning appropriate mirrored storage, configuring all the mirror processes, and monitoring that the mirror operations have been succeeding, etc. Using a data set associated with a data management policy, the administrator only has to modify the data management policy to add a mirroring stage. The storage manager 120 may then perform the tedious task of finding all the volumes which now require mirrors, provision the mirrored storage, and establish the relationships, etc. On an ongoing basis, the storage manager 120 may monitor that the mirrors are working and report a data set wide error status if not.

Storage Manager

One embodiment of the storage manager 120 may be implemented on a server as illustrated in FIG. 2. Referring to FIG. 2, the storage manager 200 includes a processor 222, a memory 224, a network interface 226, and a storage adaptor 228, which are coupled to each other via a bus system 230. The bus system 230 may include one or more busses and/or interconnects. The storage manager 200 communicates with a network (e.g., the Internet) via the network interface 226, which can be an Ethernet adaptor, fiber channel adaptor, etc. The network interface 226 may be coupled to a public network, a private network, or a combination of both in order to communicate with a client machine (such as the client machine 110) usable by an administrator of the data storage system.

In one embodiment, the processor 222 reads instructions from the memory 224 and executes the instructions. The memory 224 may include any of various types of memory devices, such as, for example, random access memory (RAM), read-only memory (ROM), flash memory, one or more mass storage devices (e.g., disks), etc. The memory 224 stores instructions of an operating system 230. The processor 222 may retrieve the instructions from the memory 224 to run the operating system 230. The storage manager 200 interfaces with the storage servers (e.g., the storage servers 110 and 112) via the storage adaptor 228, which can be a small computer system interface (SCSI) adaptor, fiber channel adaptor, etc.

### User Interface

FIGS. 3A-3C illustrate one embodiment of a series of displays of GUI to enable an administrator to create a new data set. Referring to FIG. 3A, a GUI 310 for creating new data sets is shown. The GUI 310 may be displayed via a window created by the client machine 110 in FIG. 1. The GUI 310 includes a field 312 for entry of a name of the data set and a field 314 for entry of the description of the data set. In the current example, an administrator has input “Accounting Data” as the name of a new data set. In some embodiments, the GUI 300 includes additional fields for entry of other attributes or information of the new data set, such as owner, contact, timezone.

FIG. 3B illustrates one embodiment of a display of a GUI used in creating the new data set. The GUI 320 includes a list 322 of available physical resources (e.g., available directories) to be added into the new data set. The administrator may select from the list 322 of physical resources by clicking onto the particular resource. The GUI 320 further includes a set of user interface controls 324 to allow the administrator to add the selected physical resources to the new data set. The GUI 320 includes a field 326 to display the selected physical resources in the data set.

FIG. 3C illustrates one embodiment of a display of a GUI used in creating the new data set. The GUI 330 shows a summary of the new data set created using the GUI 310 and 320 in FIGS. 3A and 3B. The administrator may verify the newly created data set using the GUI 330 and if desired, may return to the GUI 310 and/or 320, to make changes using the user interface control 332. The administrator may confirm the creation of the new data set by actuating the user interface control 334. Finally, the administrator may cancel the creation of the new data set by actuating the user interface control 336.

FIG. 3D illustrates one embodiment of a display of a GUI for applying a data management policy to a data set. The GUI 340 includes a field 342 displaying data sets created, a field 344 displaying data management policies, a field 346 to display details of a data management policy selected. An administrator may click on a data set in the field 342 to select the data set. For instance, the data set “NY Payroll” is selected in the example shown in FIG. 3D. The GUI 340 further includes user interface controls 348 to allow the administrator to add, edit, or delete a data set. The administrator may select one of the data management policies in the field 344 to apply to the selected data set by first clicking on the desired data management policy and the desired data set to select them, and then actuating the “Apply” button 349 to apply the selected policy to the selected data set. In the current example, the administrator has selected the policy of “Backed up, then mirrored” in the field 344, and details of this policy is displayed in the field 346 in graphics, text, or a combination of both.

### Process to Manage Data

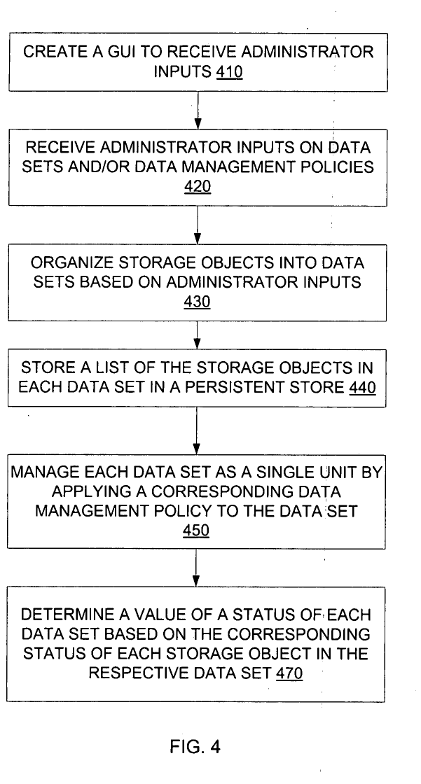

FIG. 4 illustrates a flow diagram of one embodiment of a process to manage data in a data storage system using data sets. The process is performed by processing logic that comprises hardware (e.g., circuitry, dedicated logic, etc.), software (such as is run on a general-purpose computer system or a dedicated machine, such as the storage manager 120 in FIG. 1), or a combination of both.

Referring to FIG. 4, processing logic creates a GUI to receive inputs from an administrator of the data storage system (processing block 410). Processing logic then receives administrator inputs on data sets and/or data management policies (processing block 420). For instance, the administrator may provide information via the GUI to define data sets (e.g., names and description of the data set, storage objects to be included in the data set, etc.) and to define data management policies (e.g., a data protection policy). The processing logic organizes storage objects specified by the administrator into data sets based on administrator inputs (processing block 430). Processing logic may store a list of the storage objects in each data set in a persistent store (processing logic 440). Then processing logic manages each data set as a single unit by applying a corresponding data management policy to the data set (processing block 450). For example, processing logic may apply the data manage policy by configuring the storage objects, scheduling backups of the storage objects, etc., according to the data management policy.

Further, processing logic may determine a value of a status of each data set based on the corresponding status of each storage object in the respective data set (processing block 470). Details of data sets, data management policies, and management of data using such have been described in detail above.

Some portions of the preceding detailed description are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a machine-accessible medium, also referred to as a computer-readable medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A computer-implemented method comprising:
allowing an administrator of a data storage system to define a data set including a plurality of storage objects and to associate the data set with a data management policy, wherein each of the plurality of storage objects includes a logical representation of data stored in a plurality of storage containers managed by a plurality of storage servers in the data storage system, wherein a physical implementation of the plurality of storage containers are independent of the logical representation; and
using a storage manager to manage the data set as a single unit according to the data management policy.

2. The method of claim 1, further comprising:
storing a list of the plurality of storage objects in a persistent store accessible by the storage manager.

3. The method of claim 1, further comprising:
creating a user interface to receive input from the administrator, the input including information about the data management policy, wherein the data management policy includes a data protection policy.

4. The method of claim 3, wherein managing the data set as a single unit comprises:
applying the data protection policy to each of the plurality of storage objects; and
in response to a change in the data protection policy, applying the change to each of the plurality of storage objects.

5. The method of claim 4, wherein the data protection policy includes a description of a structure of protection relationships between the replicas of the collection of data and the collection of data, and property settings of each of a plurality of components of the structure.

6. The method of claim 5, wherein the protection relationships include backup and mirror relationships.

7. The method of claim 4, wherein applying the data protection policy comprises:
backing up a first subset of the plurality of storage objects according to the data protection policy; and
mirroring a second subset of the plurality of storage objects according to the data protection policy.

8. The method of claim 1, wherein a first one of the plurality of storage objects is an elementary storage object.

9. The method of claim 8, wherein a second one of the plurality of storage objects is a reference to the elementary storage object.

10. The method of claim 1, further comprising:
determining a value of a status parameter of each of the plurality of storage objects; and
deriving a value of a corresponding status parameter of the data set from the value of the status parameter of each of the plurality of storage objects.

11. The method of claim 10, wherein the deriving the value of the corresponding status parameter of the data set comprises:
selecting a maximum value among the value of the status parameter of each of the plurality of storage objects to be the value of the corresponding status parameter of the data set.

12. The method of claim 1, further comprising:
providing a layer of abstraction to shield the administrator from the physical implementation of the storage objects; and
modifying the physical implementation of the storage objects without violating the data management policy.

13. An apparatus comprising:
a user interface module to create a user interface to allow an administrator of a data storage system to define a data set having a plurality of storage objects and to associate the data set with a data management policy, each of the plurality of storage objects includes a logical representation of data stored in a plurality of storage containers managed by a plurality of storage servers in the data storage system, wherein a physical implementation of the plurality of storage containers is independent of the logical representation; and
a storage manager to manage the data set as a single unit.

14. The apparatus of claim 13, further comprising:
an application programming interface (API) to interface the user interface with the storage manager.

15. The apparatus of claim 13, further comprising:
a persistent store coupled to the storage manager to store a list of the plurality of storage objects.

16. The apparatus of claim 13, wherein the user interface includes a graphical user interface (GUI) to display a plurality of data management policies, a plurality of data sets, and a first plurality of user interface controls to allow the administrator to apply one of the plurality of data management policies to one of the plurality of data sets.

17. The apparatus of claim 16, wherein the GUI further includes:
a second plurality of user interface controls to allow the administrator to add data sets and to delete data sets; and
a third plurality of user interface controls to allow the administrator to define a data management policy and to apply the defined data management policy to the plurality of data sets.

18. The apparatus of claim 16, wherein the GUI further includes:
a status display to output a status of each of the plurality of data sets based on a status value of each of the plurality of storage objects in a corresponding data set.

19. The apparatus of claim 13, wherein the storage manager manages the data set as a single unit by applying the data management policy to each of the plurality of storage objects and, in response to a change in the data management policy, applying the change to each of the plurality of storage objects.

20. A data storage system comprising:
a plurality of storage servers;
a client machine operable to provide a user interface to allow an administrator of the data storage system to define a data set having a plurality of storage objects, to associate the data set with a data management policy, and to monitor the data set as a single unit, wherein each of the plurality of storage objects includes a logical representation of a collection of data and replicas of the collection of data, the collection of data stored in a plurality of storage containers managed by the plurality of storage servers, wherein the plurality of storage containers are independent of the logical representation.

21. The data storage system of claim 20, further comprising:
a storage manager coupled to the plurality of storage servers and the client machine, to manage the data set as a single unit according to the data management policy by applying the data management policy to each of the plurality of storage objects and, in response to a change in the data management policy, applying the change to each of the plurality of storage objects, wherein the storage manager includes
an application programming interface (API) to interface the user interface with the storage manager.

22. The data storage system of claim 21, further comprising:
a persistent store coupled to the storage manager to store a list of the plurality of storage objects.

23. The data storage system of claim 20, wherein the user interface includes a graphical user interface (GUI) to display a plurality of data management policies, a plurality of data sets, and a first plurality of user interface controls to allow the administrator to apply one of the plurality of data management policies to one or more of the plurality of data sets.

24. The data storage system of claim 23, wherein the GUI further comprises:
a second plurality of user interface controls to allow the administrator to add data sets and to delete data sets; and
a third plurality of user interface controls to allow the administrator to define a data management policy and to apply the defined data management policy to the plurality of data sets.

25. The data storage system of claim 23, wherein the GUI further comprises:
a status display to output a status of each of the plurality of data sets based on a status value of each of the plurality of storage objects in a corresponding data set.

26. A machine-accessible medium that stores instructions which, if executed by a processor, will cause the processor to perform operations comprising:
organizing a plurality of storage objects in a network data storage system into a data set in response to a request from an administrator, wherein each of the plurality of storage objects includes a logical representation of a collection of data stored in a storage container, and wherein the logical representation is independent of the storage container;
associating the data set with a data management policy according to the request; and
managing the data set as a single unit according to the data management policy.

27. The machine-accessible medium of claim 25, wherein the operations further comprise:
storing a list of the plurality of storage objects in a persistent store accessible by a storage manager.

28. The machine-accessible medium of claim 25, wherein the operations further comprise:
creating a user interface to receive the request from the administrator, the request including information about the data management policy, wherein the data management policy includes a data protection policy.

29. The machine-accessible medium of claim 27, wherein managing the data set as a single unit comprises:
applying the data protection policy to each of the plurality of storage objects; and
in response to a change in the data protection policy, applying the change to each of the plurality of storage objects.

30. The machine-accessible medium of claim 29, wherein the data protection policy includes a description of a structure of protection relationships between the replicas of the collection of data and the collection of data, and property settings of each of a plurality of components of the structure.

31. The machine-accessible medium of claim 30, wherein the protection relationships include backup and mirror relationships.

32. The machine-accessible medium of claim 29, wherein applying the data protection policy comprises:
backing up a first subset of the plurality of storage objects according to the data protection policy; and
mirroring a second subset of the plurality of storage objects according to the data protection policy.

33. The machine-accessible medium of claim 32, wherein mirroring a second subset of the plurality of storage objects according to the data protection policy comprises:
identifying a first plurality of storage containers in which data of the second subset of the plurality of storage objects is stored;
provisioning a second plurality of storage containers for a mirror image of the second subset of the plurality of storage objects;
establishing a plurality of mirror relationships between the first plurality of storage containers and the second plurality of storage containers.

34. The machine-accessible medium of claim 33, wherein the operations further comprise:
reporting a data set wide error if one of the plurality of mirror relationships fails.

35. The machine-accessible medium of claim 26, wherein the operations further comprise:
determining a value of a status parameter of the data set based on a corresponding status parameter of each of the plurality of storage objects.
